(19) United States
(12) Patent Application Publication
(10) Pub. No.: US 2025/0136027 A1
(43) Pub. Date: May 1, 2025

(54) Vehicle

(71) Applicant: Bayerische Motoren Werke Aktiengesellschaft, Muenchen (DE)

(72) Inventors: Rico KOERNER, Muenchen (DE); Harald LATHWESEN, Mauern (DE)

(21) Appl. No.: 18/837,218

(22) PCT Filed: Feb. 22, 2023
(86) PCT No.: PCT/EP2023/054405

§ 371 Date: Aug. 9, 2024

(30) Foreign Application Priority Data
Mar. 3, 2022 (DE) 10 2022 105 030.0

(51) Int. Cl. B60R 16/027; B60R 16/02; H01B 7/00

(52) U.S. Cl. CPC B60R 16/027; B60R 16/0215; H01B 7/0045

(57) ABSTRACT

A vehicle has a device which is displaceably arranged in the vehicle and a line harness which has a first section and which transitions into a second portion via a loop. The line harness leads from a connection to the device and the device is displaceable relative to the connection. A line store is provided in which the loop of the line harness is arranged.

### BACKGROUND AND SUMMARY

The invention relates to a vehicle, in particular a car. The invention in particular discloses the line routing in the vehicle to a displaceable device.

Surplus lengths of cable harnesses, generally lines, in vehicles are usually kept available in cable loops. Such free-lying cable loops are used for example in the region of the hinges on vehicle doors or tailgates. The principle of the cable loop is particularly useful for short adjustment paths or small angle changes. In addition, the prior art also discloses so-called energy chains, which are normally composed of multiple links and in which cables can be arranged. Such energy chains usually lie freely under the action of gravity. However, in view of vibration excitation in the vehicle, the use of such an energy chain is not satisfactory without further measures, since noise can develop and/or damage can occur because of the vibration excitation.

It is an object of the present invention to provide a vehicle in which energy and/or data can be supplied to a displaceable device in a safe and convenient fashion.

The object is achieved by the features of the independent claim(s). The dependent claims concern preferred embodiments of the invention.

A vehicle according to the invention is preferably a road vehicle, in particular a car. A longitudinal axis is defined for the vehicle, wherein the vehicle travels parallel to the longitudinal axis. A vertical axis and a transverse axis of the vehicle are defined, which stand perpendicular to one another and perpendicular to the longitudinal axis.

The vehicle contains at least one displaceably arranged device. The device is preferably displaceable parallel to the longitudinal axis of the vehicle. Alternatively, the device may also be displaceable e.g. parallel to the transverse axis or parallel to the vertical axis. According to a first embodiment, the device preferably comprises a screen and, in particular, is displaceably arranged on the headlining (inner side of roof) of the vehicle. According to a second preferred embodiment, the device is configured as a seat of the vehicle. In the embodiment as a seat, the device is, in particular, displaceably arranged on the floor of the vehicle.

The vehicle has at least one line harness. The line harness is preferably a cable harness or a hose harness, or a combination of cable harness and hose harness. A “cable harness” means at least one cable which is provided to transmit current and/or data to the displaceably arranged device. In particular, the cable harness comprises multiple cables. A “hose harness” means at least one hose which is provided to transmit energy to the displaceably arranged device; in particular, the hose is configured as a hydraulic hose or pneumatic hose. In particular, the hose harness comprises multiple hoses.

The line harness may furthermore comprise a line sleeve which will be described in more detail below.

The line harness leads from a connection to the movable device. The device is displaceable relative to the connection. In particular, the connection is arranged stationarily in the vehicle. The connection may be a plug connection or merely a transition of the line harness defined here into a further cable or electronic component or into a further hose or a mechanical component, for example a valve or pump.

To describe the course of the line harness, this is divided into a first portion, a loop, preferably through 180°, and a second portion. The first portion leads from the connection to the loop. The first portion transforms into the second portion via the loop. The second portion leads from the loop to the movable device. On displacement of the device, the position of the loop changes, whereby the lengths of the two portions also change. In particular, the loop is free and is not guided on its inner periphery; only in an alternative embodiment described here does the loop run over a roller.

To describe the position and orientation of the loop, a loop axis is used below. This loop axis is in particular an imaginary axis, since—except in the alternative embodiment with a roller—the loop is not guided on its inside. On displacement of the movable device, the loop and hence its loop axis are also displaced.

The present invention is used in particular with devices which may have a relatively long travel path in the vehicle. In particular, the device described here is displaceable over at least 50 mm, preferably at least 100 mm, particularly preferably at least 200 mm. The line harness must also be correspondingly long and the loop undergoes a relatively large displacement. In order to securely receive the line harness in the region of the loop and adjacent parts of the first and second portions, preferably a line store is provided. The line store may also be called a cable store or hose store. The loop of the line harness is arranged in this line store. Thus the line harness does not lie freely in the region of its loop, but is protectively received in the line store. Thus unwanted noises and damage to the line harness caused by the usual vibration excitation the vehicle can be avoided. In addition, this avoids the line harness colliding with or becoming caught on other components of the vehicle during its movement.

As described, the device is preferably displaceable parallel to the vehicle longitudinal axis. Particularly preferably, the loop axis of the loop of the line harness stands parallel to the vehicle vertical axis. As a result, the two portions of the line harness are arranged next to one another in the vehicle transverse direction, giving a narrow structure in the vehicle vertical direction.

Furthermore, it is preferably provided that the two portions of the line harness are oriented parallel to the displacement direction of the device. When the displacement direction is oriented parallel to the vehicle longitudinal axis, thus preferably the two portions of the line harness are also oriented parallel to the vehicle longitudinal axis.

The line store preferably has a first side wall and a second side wall opposite the first side wall. At least a part of the first portion of the line harness lies against the inner face of the first side wall, and at least a part of the second portion of the line harness lies against the inner face of the second side wall. These “parts” of the portions are in particular the regions of the respective portions which are situated in the line store. In particular, it is thus provided that the two portions of the line harness-insofar as situated in the line store-lie over their complete length against the inner faces of the associated side walls.

This contact of the two portions of the line harness with the inner faces of the side walls thus ensures that the line harness is guided at the inner faces and hence does not swing freely or otherwise move. In particular, it is provided that the line harness is under pretension, in particular by the routing of the loop, and this pretension causes the two portions to lie against the inner faces of the side walls; thus the portions are pressed outward by the pretension.

As described, the line harness preferably has a line sleeve, which could also be called a cable sleeve or hose sleeve. At least one line of the line harness, i.e. at least one cable or hose, is situated in this line sleeve. The line sleeve is preferably formed elastic in order to press the two opposite portions apart in the line store to lie against the two side walls; in particular by routing of the loop, thereby creating the pretension in the elastic line sleeve.

The line sleeve may in principle be made of any material. Particularly preferably, it is considered that the line harness in the vehicle may be exposed to relatively high temperatures. For example, if the device is situated in the headlining or roof region of the vehicle, under corresponding solar radiation onto the line harness, a temperature of above 100° C. may occur. Therefore it is preferably provided that the line sleeve comprises elastic elements of metal or heat-resistant plastic, since such elastic elements can retain their elasticity even at high temperatures. The elastic elements of the line sleeve are in particular configured to press the two opposite portions apart in the line store so that they lie against the two side walls.

The line sleeve may for example be configured as an energy chain. In particular, this energy chain has corresponding elastic elements in order to press the two portions apart. Furthermore, the line sleeve may be configured as a different casing, for example as a metal coil spring which contains the at least one line. It is furthermore also provided that the line sleeve is a fixed component of the line, for example a layer of the line insulation which has the required elastic properties.

Additionally or alternatively to the design of the line sleeve, a magnetic design of the line harness and provision of a corresponding counter-element may ensure that at least one of the two portions of the line harness lies against the associated side wall. It is here firstly provided that the line harness, in particular the line sleeve, is magnetic. Furthermore, at least one magnetic counter-element is arranged on the line store, or the line store itself is configured as a magnetic counter-element so that the magnetic counter-element is an integral part of the line store. At least one of the magnetic elements, namely the magnetic line harness and/or the magnetic counter-element, is configured as a permanent magnet. The respective other element must at least be magnetizable, e.g. made of steel.

The magnetic counter-element, as an integral part of the line store or arranged in the vicinity of the line store, draws the line harness against the inner face of the associated side wall. Particularly preferably, the magnetic counter-element is situated in the region of the first portion of the line harness, i.e. in the portion leading from the stationary connection to the loop.

However, it is also provided that, additionally or alternatively, the magnetic counter-element is arranged in the region of the second portion of the line harness, i.e. on the portion which leads from the loop to the movable device. It is particularly preferably provided here that the magnetic counter-element is displaceable together with the device. Here, in particular, the magnetic counter-element is directly or indirectly connected to the device, so that the magnetic counter-element moves simultaneously with the device. This avoids the need to press the line harness onto the associated inner face of the side wall against the magnetic force.

As described, the line store preferably comprises the two side walls. The inner faces of the two side walls preferably extend in a plane standing parallel to the loop axis and parallel to the displacement direction of the device; i.e. in particular a plane which is spanned by the vehicle longitudinal axis and the vehicle vertical axis.

In addition to the side walls, the line store preferably comprises a rear wall with concave inner face. When the displaceable device is in one of its two end positions, the loop axis or the loop may be inserted into the line store so far that the loop of the line harness lies against this concave inner face of the rear wall.

Moreover, it is preferably provided that the line store has a floor. The floor connects together the two side walls and preferably also the rear wall. In particular, the inner face of the floor stands perpendicular to the two side walls. Particularly preferably, it is provided that the floor is made of one piece together with the rear wall and two side walls, for example of plastic.

Preferably, the line store also has a cover which is arranged opposite the floor. The cover may be removable and allows the line harness to be laid in the line store initially without cover, and then the line store closed by the cover.

As described, the pretension generated by the line sleeve presses the two portions outward against the opposite side walls. Preferably, the line sleeve is also configured such that the portions are pressed by pretension not only against the side walls but also against the cover and floor of the line store.

In particular, the line store has a large opening through which the line harness can be inserted and extracted. Alternatively, the line store has two openings so that each portion of the line harness can penetrate into the line store through its own opening.

A length of the line store is in particular adapted to a displacement length of the device, so that taking into account the maximum displacement length of the device, the loop axis always remains in the interior of the line store.

Preferably, at least one guide rail is arranged in the vehicle. In particular, two opposite guide rails are provided. The device is preferably displaceably guided on the at least one guide rail. The line store is preferably arranged in or on the guide rail. In particular, the line store may be attached to the guide rail. The line store may protrude out of the guide rail at an end face of the guide rail. The line harness may be received in the guide rail outside the line store.

In the case of very long displacement paths, preferably a deflector is provided in the vehicle. This deflector is situated in particular in the region of the second portion of the line harness, i.e. between the displaceable device and the loop in the line store. Thus the second portion of the line harness runs through the deflector and forms a stationary deflection loop inside the deflector. In particular, the deflection amounts to 180°.

As stated initially, in an alternative embodiment, the loop may not be guided freely in the line store but routed around a roller. This roller is displaceably arranged in the line store. In particular, the roller is displaceable parallel to the displacement direction of the device, in particular parallel to the vehicle longitudinal axis. Particularly preferably, it is provided that the roller is spring-loaded with respect to its displaceability. In particular, the roller is thus attached to the line store via a spring. The roller preferably moves against the spring force when the line harness is drawn out of the line store, and in the opposite direction it is drawn in again towards the rear wall of the line store by means of the spring force. Also, by use of this roller, it is possible to guide the line harness in as defined a fashion as possible, in order thus to avoid unwanted noises and damage to the line harness under vibrational loading in the vehicle.

Further details, features and advantages of the invention arise from the following description and the figures.

### BRIEF DESCRIPTION OF THE DRAWINGS

FIGS. 1 and 2 show a schematic view of a vehicle according to the invention with a displaceable device in two different positions, for all exemplary embodiments.

FIGS. 3 and 4 show a variant of the vehicle according to the invention with the displaceable device in its two end positions, according to all exemplary embodiments.

FIG. 5 shows a detail of the vehicle according to the invention with a closed line store, according to a first exemplary embodiment of the invention.

FIG. 6 is an illustration similar to FIG. 5 with an open line store, wherein the displaceable device is in a first end position.

FIG. 7 is an illustration similar to FIG. 5 with the open line store, wherein the displaceable device is in its second end position.

FIG. 8 shows a detail of the vehicle according to the invention with a line store and magnetic counter-elements, according to a second embodiment of the invention.

FIG. 9 shows a detail of the vehicle according to the invention with a line store and deflecting roller, according to a third exemplary embodiment of the invention.

### DETAILED DESCRIPTION OF THE DRAWINGS

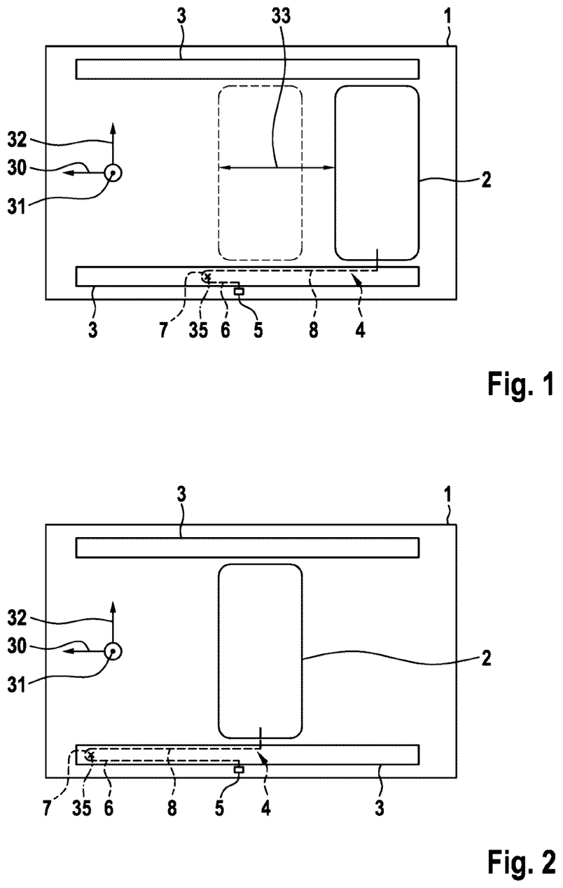

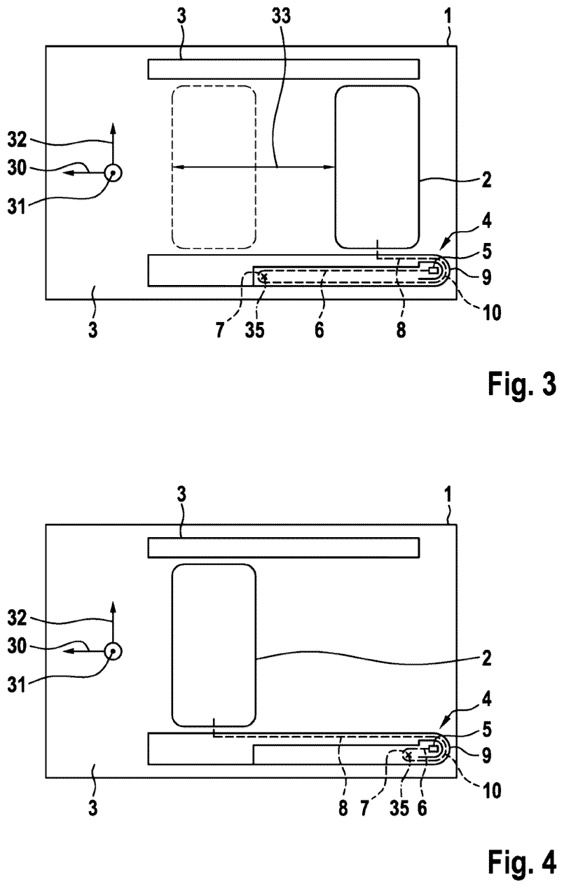

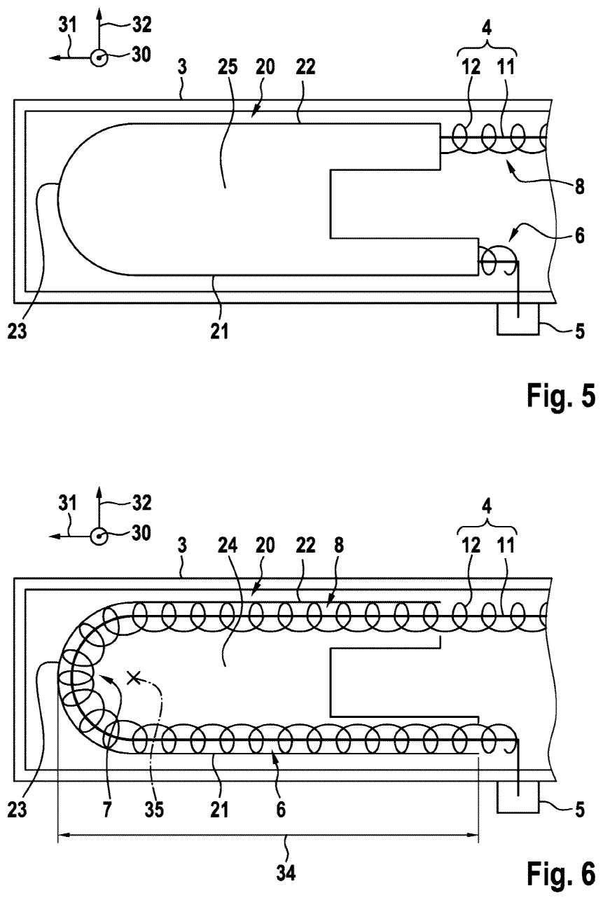

The basic structure of a vehicle 1 is now described purely schematically with reference to FIGS. 1 to 4. FIGS. 1 and 2 show the line routing with only one deflection, which is preferably used if there is installation space for a line store 20 in front of the displacement kinematics, namely the installation space in the line store 20. FIGS. 3 and 4 show an additional deflection which in particular is used if the line store 20 must lie next to a displaceable device 2, because e.g. there is insufficient installation space available in front of the displaceable device 2. In addition, with reference to FIGS. 5 to 9, three different embodiments of the line store 20 of the vehicle 1 are explained.

According to FIGS. 1 to 4, the vehicle 1 has a headlining (also: inner side of the roof), illustrated purely schematically. The vehicle 1 is shown in plan view. The longitudinal axis 30, the vertical axis 31 and the transverse axis 32 of the vehicle 1 are marked accordingly.

The vehicle 1 has a linearly displaceable device 2. In the exemplary embodiment shown, this is a device 2 with a screen which extends over a substantial part of the vehicle width. The device 2 is displaceable from its first end position into a second end position lying further forward relative to the vehicle 1. FIG. 1 shows in dotted lines the front end position of the device 2 and the associated maximum displacement length 33.

The vehicle 1 comprises two guide rails 3 (illustrated schematically) which extend along the vehicle longitudinal axis 30. The device 2 is guided on the guide rails 3.

FIGS. 1 to 4 also show, purely schematically, a connection 5. A line harness 4 (illustrated schematically) leads from this stationary connection 5 to the movable device 2.

The line harness 4 is divided into a first portion 6 which transforms into a second portion 8 via a loop 7. The first portion 6 extends from the connection 5 to the loop 7. The second portion 8 extends from the loop 7 to the device 2. The loop 7 lies around an imaginary axis 35. The loop axis 35 runs parallel to the vehicle vertical axis 31. When the device 2 is displaced, the position of the loop 7 or loop axis 35 moves, as evident from a combined view of FIGS. 1 and 2 or 3 and 4.

The loop 7 is designed for deflection of the line harness 4 through 180°.

FIGS. 3 and 4 show a variant which allows as large as possible a displacement length of the device 2, taking into account the limited installation space in the vehicle 1. It is evident that the vehicle 1 has a 180° deflector 9. This deflector 9 is situated in particular in or on the guide rail 3. A deflection loop 10 of the second portion 8 of the line harness 4 runs through this deflector 9. In contrast to the loop 7, the deflection loop 10 remains stationary in the deflector 9.

To receive the loop 7, the vehicle 1 comprises the line store 20. This line store 20 is not shown in FIGS. 1 to 4 for the sake of clarity. The line store 20 is situated in the region of the marked loop 7 or loop axis 35 in FIGS. 1 to 4, and its storage length 34 is sufficiently long that the loop axis 35 always remains inside the line store 20, i.e. in both end positions of the device 2.

The schematic, detail illustrations in FIGS. 5 to 9 show the line store 20. This is preferably situated in or on the guide rail 3. The line store 20 may also be arranged outside the guide rail 3 or at least protrude from the end face of the guide rail 3.

As FIGS. 5 to 9 show schematically, the line store 20 has a first side wall 21 and a second side wall 22. The two side walls 21, 22 stand opposite one another. Furthermore, the two side walls 21, 22 transform into a rear wall 23 of the line store 20. The rear wall 23 has a concave inner face.

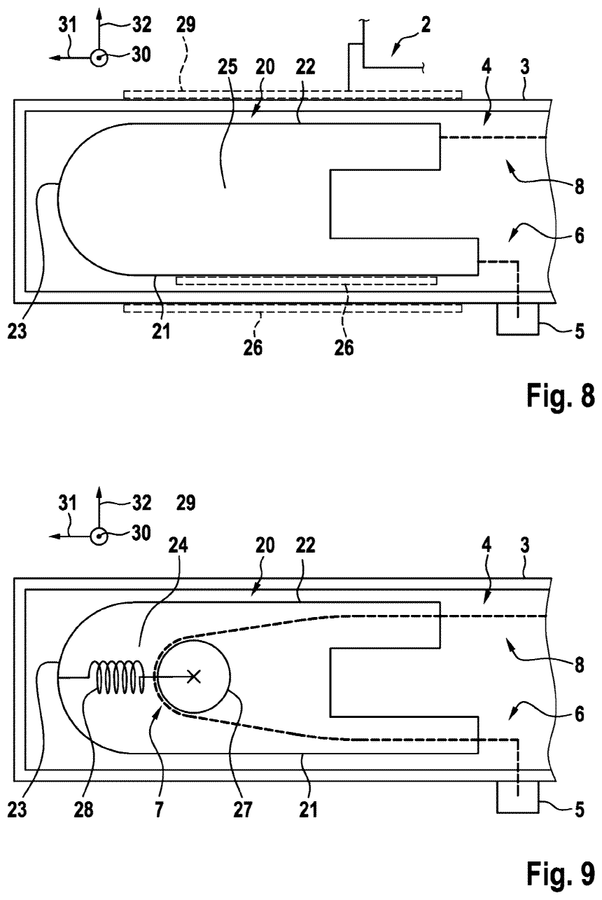

FIGS. 5 and 8 show the line store 20 with applied cover 25. In FIGS. 6, 7 and 9, the cover 25 is removed, revealing a floor 24 of the line store 20. In particular, it is provided that the floor 24 connects together the two side walls 21, 22 and the rear wall 23. The cover 25 may be removable or connected to the side walls 21, 22 in a fixed configuration.

It is clear from FIGS. 5, 6 and 7, which schematically illustrate the first embodiment, that the line harness 4 comprises at least a line 11 and a line sleeve 12. The line sleeve 12 is formed elastic so that inside the line store 20, it presses the two opposite portions 6, 8 against the inner faces of the two opposite side walls 21, 22. For example, for this the line sleeve 12 comprises metallic elastic elements; it is for example formed as a helix, in particular a coil spring. However, the line sleeve 12 is here shown purely schematically and may be configured differently, as explained in the general part of the description.

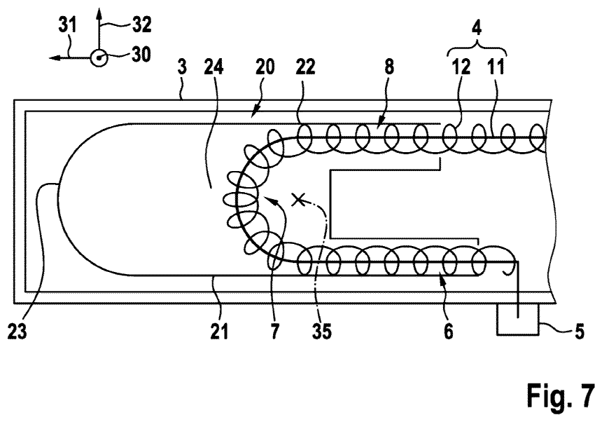

FIGS. 6 and 7 show the position of the loop inside the line store 20 in the two end positions of the device 2. It is clear that, in view of the displacement length 33, the storage length 34 of the line store 20 is formed sufficiently large that the loop 7 is always situated inside the line store 20.

FIG. 8 shows purely schematically a possible way in which, additionally or alternatively to use of the elastic line sleeve 12 (according to the first exemplary embodiment), at least one portion of the line harness 4 may be brought to lie against the inner face of the associated side wall 21, 22. According to the second exemplary embodiment, the line harness 4, in particular the line sleeve 12, is formed magnetic. In addition, at least a fixed counter-element 26 and/or a displaceable counter-element 29 is used. The counter-element 26, 29 is also magnetic. The term “magnetic” means that the counter-element 26, 29 and/or the line harness 4 is permanently magnetic; if one of the elements is not permanently magnetic, it must be at least magnetizable, e.g. made of steel.

FIG. 8 shows various positions for arrangement of the at least one counter-element 26. This may be arranged in or on the guide rail 3. Additionally or alternatively, the counter-element 26 may be arranged in or on the line store 20. It is also possible to form the line store 20 itself as a magnetizable counter-element 26.

The at least one fixed counter-element 26 draws the first portion 6 of the line harness 4 against the inner wall of the first side wall 21 so as to lie against this inner face.

On the opposite side, preferably a displaceable counter-element 29 is used. This displaceable counter-element 29 is directly or indirectly connected to the device 2 and can thus move linearly together with the device 2. The displaceable counter-element 29 magnetically draws the second portion 8 of the line harness 4 against the inner face of the second side wall 22.

In the context of the third exemplary embodiment, FIG. 9 illustrates how, additionally or alternatively to the designs of the first two exemplary embodiments, the loop 7 of the line harness 4 can be routed around a roller 27. The roller 27 is linearly movable inside the line store 20, in particular parallel to the vehicle longitudinal axis 30. As FIG. 9 shows schematically, the roller 27 is preferably connected to the line store 20 via a spring 28, so that the roller 27 is movable in one direction against the spring force and in the other direction by the spring force.

### LIST OF REFERENCE SIGNS

1 Vehicle
2 Device
3 Guide rail
4 Line harness
5 Connection
6 First portion
7 Loop
8 Second portion
9 Deflector
10 Deflection loop
11 Line
12 Line sleeve
20 Line store
21 First side wall
22 Second side wall
23 Rear wall
24 Floor
25 Cover
26 Fixed counter-element
27 Roller
28 Spring
29 Displaceable counter-element
30 Vehicle longitudinal axis
31 Vehicle vertical axis
32 Vehicle transverse axis
33 Displacement length
34 Storage length
35 Loop axis

1-10. (canceled)

11. A vehicle, comprising:
a device which is displaceably arranged in the vehicle;
a line harness having a first portion which transitions into a second portion via a loop,
wherein the line harness leads from a connection to the device, wherein the device is displaceable relative to the connection; and
and a line store, in which the loop of the line harness is arranged.

12. The vehicle according to claim 11, wherein
the line store comprises a first side wall and an opposite second side wall,
at least a part of the first portion lies against an inner face of the first side wall, and
at least a part of the second portion lies against an inner face of the second side wall.

13. The vehicle according to claim 12, wherein
the line harness comprises a line sleeve and at least one line in the line sleeve, and
the line sleeve is elastic in order to press the opposite first and second portions apart in the line store such that they lie against the first and second side walls.

14. The vehicle according to claim 12, wherein
the line harness is magnetic; and
at least one magnetic counter-element is arranged or formed as an integral part of the line store, wherein
at least one of the first and second portions lies against an associated one of the first and second side walls because of magnetic attraction between the line harness and counter-element.

15. The vehicle according to claim 12, wherein
the first and second side walls are connected together via a rear wall of the line store, the rear wall having a concave inner face.

16. The vehicle according to claim 12, wherein
the line store has a floor which connects together the first and second side walls, and
the line store has a cover opposite the floor.

17. The vehicle according to claim 11, further comprising:
a guide rail on which the device is displaceably guided, wherein
the guide rail is arranged in the vehicle, and
the line store is arranged in or on the guide rail.

18. The vehicle according to claim 11, further comprising:
a deflector through which a stationary deflection loop of the second portion of the line harness is guided.

19. The vehicle according to claim 11, wherein
the device comprises a screen and is arranged on a headlining of the vehicle, or
the device is configured as a seat and is arranged on a floor of the vehicle.

20. The vehicle according to claim 11, wherein
at the loop, the line harness is routed around a roller, and
the roller is arranged displaceably in the line store.
